(19) United States
(12) Patent Application Publication
(10) Pub. No.: US 2022/0180387 A1
(43) Pub. Date: Jun. 9, 2022

(54) INFORMATION PROCESSING APPARATUS, INFORMATION PROCESSING SYSTEM, AND INFORMATION PROCESSING METHOD

(71) Applicant: TOSHIBA TEC KABUSHIKI KAISHA, Tokyo (JP)

(72) Inventors: Toru TERAUCHI, Nerima Tokyo (JP); Kazunari KOGURE, Kita Tokyo (JP); Toshihide MURATA, Kawasaki Kanagawa (JP); Takuma TANAKA, Izunokuni Shizuoka (JP)

(21) Appl. No.: 17/406,033

(22) Filed: Aug. 18, 2021

(30) Foreign Application Priority Data
Dec. 3, 2020 (JP) 2020-201233

(51) Int. Cl. G06Q 30/02

(52) U.S. Cl. CPC G06Q 30/0217; G06Q 30/0203; G06Q 30/0211; G06Q 30/0236

(57) ABSTRACT

According to an embodiment, an information processing apparatus acquires, from a payment apparatus, transaction data, user identification data, and planning identification data. The information processing apparatus acquires, from a first management database, a product code associated with the planning identification data. The information processing apparatus acquires, from a second management database, an achievement status of a reward providing condition. The information processing apparatus determines, on the basis of whether or not the transaction data includes the product code and of the achievement status of the reward providing condition, necessity of provision of a reward to a subject corresponding to the user identification data.

### CROSS-REFERENCE TO RELATED APPLICATIONS

This application is based upon and claims the benefit of priority from the prior Japanese Patent Application No. 2020-201233, filed on Dec. 3, 2020, the entire contents of which are incorporated herein by reference.

### FIELD

An embodiment to be described here generally relates to an information processing apparatus, an information processing system, and an information processing method.

### BACKGROUND

In recent years, companies have been gathering impressions of products from consumers through questionnaires. For example, there is a questionnaire method using receipts. In this method, a POS (Point Of Sales) terminal outputs a receipt on which a two-dimensional code symbol that has set a URL (Uniform Resource Locator) leading to a questionnaire site has been printed. A consumer reads the two-dimensional code symbol by a portable terminal, accesses the questionnaire site, and answers the questionnaire on the web page.

However, a questionnaire involving a reward to a consumer often asks the consumer to register personal information of the consumer, and the like. For this reason, the consumer needs to perform a complicated registering task of registering personal information or the like in order to answer the questionnaire and receive a reward.

Further, in the past, there have been various types of reward providing planning for providing rewards to a consumer when the consumer browses a campaign screen on a web page or views an advertisement movie on a web page. Even in such reward providing planning, there is a need for a technology that does not require a complicated task for consumers and efficiently provides rewards.

### BRIEF DESCRIPTION OF DRAWINGS

FIG. 1 is a block diagram illustrating an information processing system according to an embodiment;

FIG. 2 is a diagram illustrating an issuing condition management database according to the embodiment;

FIG. 3 is a diagram illustrating a use condition management database according to the embodiment;

FIG. 4 is a diagram illustrating an achievement status management database according to the embodiment;

FIG. 5 is a sequence diagram illustrating a procedure of reward providing processing of the information processing system according to the embodiment;

FIG. 6 is a sequence diagram illustrating a procedure of the reward providing processing of the information processing system according to the embodiment;

FIG. 7 is a flowchart illustrating information processing executed by a processor of a POS terminal of the information processing system according to the embodiment;

FIG. 8 is a flowchart illustrating information processing executed by a processor of a receipt server of the information processing system according to the embodiment; and

FIG. 9 is a flowchart illustrating details of the reward determining processing in FIG. 8.

### DETAILED DESCRIPTION

In accordance with an embodiment, an information processing apparatus manages reward providing planning for providing a reward to a user. The information processing apparatus includes a communication interface, a first management database, a second management database, and a processor. The communication interface communicates with a payment apparatus that performs payment for a product. The first management database stores, in association with a product code for identifying a product, planning identification data for identifying reward providing planning. The second management database stores, in association with user identification data for identifying a user, an achievement status of a reward providing condition determined for each linked destination. The processor acquires transaction data, the user identification data, and the planning identification data from the payment apparatus via the communication interface, the transaction data including at least one of a product code or a total amount of a product to be paid. The processor acquires, from the first management database, the product code associated with the acquired planning identification data. The processor acquires, from the second management database, the achievement status of the reward providing condition associated with the acquired user identification data. In addition, the processor determines, on the basis of whether or not the acquired transaction data includes the acquired product code and of the acquired achievement status of the reward providing condition, necessity of provision of a reward to a subject corresponding to the acquired user identification data.

Hereinafter, an embodiment will be described with reference to the drawings. The same reference symbols in the drawings will denote the same or similar portions.

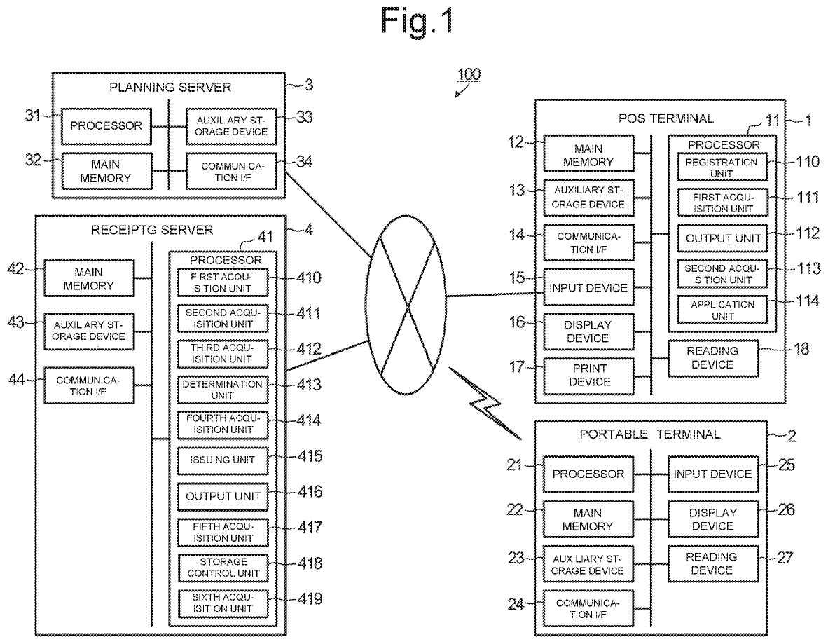

FIG. 1 is a block diagram illustrating an information processing system 100 according to an embodiment. The information processing system 100 includes a POS terminal 1, a portable terminal 2, a planning server 3, and a receipt server 4. The POS terminal 1, the portable terminal 2, the planning server 3, and the receipt server 4 are communicably connected to each other via a network. For example, the network is the Internet. Note that the information processing system 100 refers to a system including at least two apparatuses of the POS terminal 1, the portable terminal 2, the planning server 3, and the receipt server 4 in some cases.

The POS terminal 1 is installed in a store and performs payment (accounting) for products. The POS terminal 1 supports both offline payment and payment through communication with a payment center. For example, the offline payment is payment by cash, a gift certificate, or the like. For example, the payment through communication with a payment center is payment by a credit card, electronic money, a debit card, code payment, or the like. A configuration example of the POS terminal 1 will be described. Note that although only one POS terminal 1 is shown in FIG. 1, the POS terminal 1 may include a plurality of POS terminals.

The portable terminal 2 is an apparatus capable of communicating with another apparatus. The portable terminal 2 is an apparatus owned by a consumer. For example, the portable terminal 2 is a smartphone, a tablet terminal, or the like. A configuration example of the portable terminal 2 will be described. The consumer may be read as a customer, a user, or a person. Note that only one portable terminal 2 is shown in FIG. 1, the portable terminal 2 may include a plurality of portable terminals.

The planning server 3 is an apparatus that manages data of a planning response of a consumer with respect to reward providing planning. For example, in the case where the reward providing planning is a questionnaire relating to a product, the planning server 3 manages data of various questionnaire sites and answers to the questionnaire. The reward is a reward valuable for a consumer. For example, the reward is a coupon such as a discount coupon and a free coupon. However, it goes without saying that the reward is not limited to a coupon and may be a point grant, stamping, or the like. Note that in the following description, the data of a planning response with respect to reward providing planning and the data of an answer to a questionnaire Will be respectively abbreviated as a response and an answer in some cases. A configuration example of the planning server 3 will be described below. Note that only one planning server 3 is shown in FIG. 1, but the planning server 3 may include a plurality of planning servers.

The receipt server 4 is an apparatus that provides a reward to a consumer. The receipt server 4 is an example of the information processing apparatus. A configuration example of the receipt server 4 will be described below.

A configuration example of the POS terminal 1 will be described. As shown in FIG. 1, the POS terminal 1 is a computer including a processor 11, a main memory 12, an auxiliary storage device 13, a communication interface 14, an input device 15, a display device 16, a printing device 17, and a reading device 18. The respective units constituting the POS terminal 1 are connected to each other so as to be capable of inputting/outputting signals to/from each other. In FIG. 1, the interface is described as “I/F”.

The processor 11 corresponds to the central part of the POS terminal 1. For example, the processor 11 is a CPU (Central Processing Unit) but is not limited thereto. The processor 11 may include various circuits. The processor 11 expand, to the main memory 12, the program stored in the main memory 12 or the auxiliary storage device 13. The program is a program that causes the processor 11 of the POS terminal 1 to realize the respective units described below. The processor 11 executes the program expanded to the main memory 12 to execute various operations.

The main memory 12 corresponds to the main storage part of the POS terminal 1. The main memory 12 includes a non-volatile memory area and a volatile memory area. The main memory 12 stores an OS (Operating System) or a program in the non-volatile memory area. The volatile memory area of the main memory 12 is used as a work area in which data is rewritten by the processor 11 as appropriate. For example, the main memory 12 includes a ROM (Read Only Memory) as the non-volatile memory area. For example, the main memory 12 includes a RAM (Random Access Memory) as the volatile memory area.

The auxiliary storage device 13 corresponds to the auxiliary storage part of the POS terminal 1. For example, the auxiliary storage device 13 is an EEPROM (registered trademark) (Electric Erasable Programmable Read-Only Memory), an HDD (Hard Disc Drive), or an SSD (Solid State Drive). The auxiliary storage device 13 stores the above-mentioned program, data used when the processor 11 executes various types of processing, and data generated by the processing in the processor 11.

The communication interface 14 includes various interfaces for communicably connecting the POS terminal 1 to another apparatus via a network in accordance with a predetermined communication protocol.

The input device 15 is a device capable of inputting data or an instruction to the POS terminal 1. For example, the input device 15 is a keyboard or a touch panel.

The display device 16 is a device capable of displaying various screens under the control of the processor 11. For example, the display device 16 is a liquid crystal display or an EL (Electroluminescence) display.

The printing device 17 is a device that prints information on a receipt or the like. For example, the printing device 17 is a thermal printer or an inkjet printer.

The reading device 18 is a device capable of reading various types of data. For example, the reading device 18 includes a reader capable of reading data from a contact IC card. For example, the reading device 18 includes a reader capable of reading data from a contactless IC card or a recording medium using RFID (Radio Frequency Identification). For example, the reading device 18 includes a reader capable of reading data from a magnetic stripe of a card medium. For example, the reading device 18 includes a scanner capable of reading data from a code symbol. The code symbol is, for example, a two-dimensional code symbol such as a bar code symbol and a QR code (registered trademark). The scanner may be of a type that reads a code symbol by laser beam scanning or of a type that reads a code symbol from an image captured by an imaging device.

Note that the hardware configuration of the POS terminal is not limited to the above-mentioned configuration. In the POS terminal 1, the above-mentioned components may be omitted or changed and a new component may be added as appropriate.

The respective units to be mounted on the above-mentioned processor 11 will be described. As shown in FIG. 1, the processor 11 includes a registration unit 110, a first acquisition unit 111, an output unit 112, a second acquisition unit 113, and an application unit 114. The respective units to be mounted on the processor 11 can be referred to also as respective functions. It can also be said that the respective units to be mounted on the processor are to be mounted on a control unit including the processor 11 and the main memory 12.

The registration unit 110 registers a product code of a product to be purchased and the number of the products in a product-to-be-purchased register provided in the main memory 12 or the auxiliary storage device 13. The product code is a code for uniquely identifying a product. For example, the product code is a JAN code. The product code is set in, for example, a code symbol attached to each product, and is acquired by reading the corresponding code symbol by the reading device 18. Alternatively, the product code is input from the input device 15 by a sales clerk who operates the POS terminal 1.

The first acquisition unit 111 acquires information set in the two-dimensional code symbol printed on a planning receipt, which has been read by the reading device 18. The planning receipt and the procedure of issuing the planning receipt will be described below. The information set in the two-dimensional code symbol may include a URL and a query parameter, and the query parameter includes a user ID (user identification data), a planning ID (planning identification data), a service code, and a coupon code.

The URL is a URL of a web page relating to reward planning. A URL of a web page relating to a questionnaire is an example of linked-destination information to the questionnaire. Hereinafter, the URL of a web page relating to a questionnaire will be abbreviated as a URL in some cases.

The user ID is an individual ID for uniquely identifying a combination of reward planning and an individual consumer. The user ID is issued by the receipt server 4 described below without specifying the personal information of the corresponding consumer. For example, the user ID associated with the answer of a consumer X to a reward planning A is different from the user ID associated with the answer of a consumer Y to the reward planning A. The user ID associated with the answer of the consumer X to the reward planning A is different from the user ID associated with the answer of the consumer X to a reward planning B.

The planning ID is an ID for uniquely identifying reward planning such as a questionnaire.

The service code is a code for uniquely identifying a service type. Examples of the service type include a questionnaire, an advertisement, and a campaign. The questionnaire is a service that provides a reward to a subject who has answered the questionnaire. The advertisement is a service that provides a reward to a subject who has browsed the advertisement. The campaign is a service that provided a reward to a subject who has browsed the campaign screen on a web page, i.e., a subject who has accessed the web page.

The coupon code is a code for uniquely identifying content of a coupon. The coupon code is uniquely assigned to reward planning such as a questionnaire. The auxiliary storage device 13 of the POS terminal 1 stores, in association with the coupon code, the content of a reward, e.g., what subtotal discount is to be made for which product, what discount is to be made for the total amount, or how many points are to be given.

The output unit 112 creates transaction data including at least one of the total amount of a product indicated by a product code registered by the registration unit 110 or the registered product code, and outputs the created transaction data to the receipt server 4 via a network. Further, in the case where the first acquisition unit 111 has acquired a user ID and a planning ID, the output unit 112 outputs the transaction data, the user ID, and the planning ID to the receipt server 4 via a network.

The second acquisition unit 113 acquires a determination result that is a result of determining the necessity of provision of a reward to a subject of reward provision, which is transmitted from the receipt server 4 via a network.

In the case where the acquired determination result indicates that the reward provision is necessary, the application unit 114 applies a reward to a subject.

Note that although the registration unit 110, the first acquisition unit 111, the output unit 112, the second acquisition unit 113, and the application unit 114 have been described as being mounted on the processor 11 by executing a program, the present disclosure is not limited thereto. The output unit 112 and the second acquisition unit 113 relates to data communication between the POS terminal 1 and another apparatus. For this reason, the communication interface 14 may be an example of the output unit 112 and the second acquisition unit 113. The output unit 112 and the second acquisition unit 113 may be realized by cooperation of the processor 11 and the communication interface 14 by executing a program.

A configuration example of the portable terminal 2 will be described. As shown in FIG. 1, the portable terminal 2 is a computer including a processor 21, a main memory 22, an auxiliary storage device 23, a communication interface 24, an input device 25, a display device 26, and a reading device 27. The respective units constituting the portable terminal 2 are connected to each other so as to be capable of inputting/outputting signals to/from each other.

The processor 21 corresponds to the central part of the portable terminal 2. The processor 21 has a hardware configuration similar to that of the above-mentioned processor 11. The processor 21 executes a program stored in the main memory 22 or the auxiliary storage device 23 in advance to execute various operations.

The main memory 22 corresponds to the main storage part of the portable terminal 2. The main memory 22 has a hardware configuration similar to that of the above-mentioned main memory 12. The main memory 22 stores a program.

The auxiliary storage device 23 corresponds to the auxiliary storage part of the portable terminal 2. The auxiliary storage device 23 has a hardware configuration similar to that of the above-mentioned auxiliary storage device 13. The auxiliary storage device 23 stores the above-mentioned program.

The communication interface 24 includes various interfaces for communicably connecting the portable terminal to another apparatus via a network in accordance with a predetermined communication protocol.

The input device 25 is a device capable of inputting data or an instruction to the portable terminal 2. For example, the input device 25 is a keyboard or a touch panel.

The display device 26 is a device capable of displaying various screens under the control of the processor 21. For example, the display device 26 is a liquid crystal display or an EL display.

The reading device 27 is a device capable of reading various types of data. For example, the reading device 27 includes a scanner capable of reading data from a two-dimensional code symbol, similarly to the reading device 18.

Note that the hardware configuration of the portable terminal 2 is not limited to the above-mentioned configuration. In the portable terminal 2, the above-mentioned components may be omitted or changed and a new component may be added as appropriate.

A configuration example of the planning server 3 will be described. As shown in FIG. 1, the planning server 3 is a computer including a processor 31, a main memory 32, an auxiliary storage device 33, and a communication interface 34. The respective units constituting the planning server 3 are connected to each other so as to be capable of inputting/outputting signals to/from each other.

The processor 31 corresponds to the central part of the planning server 3. The processor 31 has a hardware configuration similar to that of the above-mentioned processor 11. The processor 31 expands, to the main memory 32, the program stored in the main memory 32 or the auxiliary storage device 33. The program is a program that causes the processor 31 of the planning server 3 to realize the respective units described below. The processor 31 executes the program expanded to the main memory 32 to execute various operations.

The main memory 32 corresponds to the main storage part of the planning server 3. The main memory 32 has a hardware configuration similar to that of the above-mentioned main memory 12. The main memory 32 stores a program.

The auxiliary storage device 33 corresponds to the auxiliary storage part of the planning server 3. The auxiliary storage device 33 has a hardware configuration similar to that of the above-mentioned auxiliary storage device 13. The auxiliary storage device 33 stores the above-mentioned program. The auxiliary storage device 33 is an example of the storage unit.

The communication interface 34 includes various interfaces for communicably connecting the planning server 3 to another apparatus via a network in accordance with a predetermined communication protocol.

Note that the hardware configuration of the planning server 3 is not limited to the above-mentioned configuration. In the planning server 3, the above-mentioned components may be omitted or changed and a new component may be added as appropriate.

The respective units to be mounted on the above-mentioned processor 31 will be described. The processor 31 includes a response unit, an acquisition unit, a storage control unit, and an output unit although particularly not shown. The respective units to be mounted on the processor 31 can be referred to also as respective functions. It can also be said that the respective units to be mounted on the processor 31 are to be mounted on a control unit including the processor 31 and the main memory 32.

The response unit of the processor 31 outputs a web page relating to reward planning as a response to a request for a webpage relating to reward planning from the portable terminal 2, e.g., a questionnaire. The acquisition unit of the processor 31 acquires a response such as an answer to a questionnaire transmitted from the portable terminal 2. The storage control unit of the processor 31 stores the acquired response in the auxiliary storage device 33 in association with the user ID. The auxiliary storage device 33 accumulates answers for each questionnaire. The output unit of the processor 31 outputs, to the receipt server 4, data of the achievement status of reward planning such as an answer status to the questionnaire, in association with the user ID. For example, the output unit outputs data indicating completion notification, which includes data of the user ID and the achievement status associated with each other. Hereinafter, the data indicating completion notification will be abbreviated as completion notification in some cases. The data of the achievement status of the reward planning is abbreviated as an achievement status in some cases. The achievement status represents the state of responses to the reward planning. For example, the achievement status includes achievement completion information. The achievement completion information is information indicating that the response has been completed.

The achievement status may further include response content information. The response content information is information that changes depending on the content of the response. For example, the response content information is information regarding the point of the content of the response. The point of the response content may change depending on the rating in the response. For example, in the case where the reward planning is a questionnaire relating to a product, the point of the response content can be high when the response, i.e., the rating of this product is high in the answer to the questionnaire. Meanwhile, when the rating of the product is low in the answer to the questionnaire, the point of the response content can be low. The point of the response content may be set by the processor 31 in accordance with a predetermined rule on the basis of the response. The point of the response content may be set by an administrator of the planning server 3 on the basis of the response.

A configuration example of the receipt server 4 will be described. As shown in FIG. 1, the receipt server 4 is a computer including a processor 41, a main memory 42, an auxiliary storage device 43, and a communication interface 44. The respective units constituting the receipt server 4 are connected to each other so as to be capable of inputting/outputting signals to/from each other.

The processor 41 corresponds to the central part of the receipt server 4. The processor 41 has a hardware configuration similar to that of the above-mentioned processor 11. The processor 41 expands, to the main memory 42, the program stored in the main memory 42 or the auxiliary storage device 43 in advance. The program is a program that causes the processor 41 of the receipt server 4 to realize the respective units described below. The processor 41 executes the program expanded to the main memory 42 to execute various operations.

The main memory 42 corresponds to the main storage part of the receipt server 4. The main memory 42 has a hardware configuration similar to that of the above-mentioned main memory 12. The main memory 42 stores a program.

The auxiliary storage device 43 corresponds to the auxiliary storage part of the receipt server 4. The auxiliary storage device 43 has a hardware configuration similar to that of the above-mentioned auxiliary storage device 13. The auxiliary storage device 43 is an example of the storage unit. The auxiliary storage device 43 stores the above-mentioned program.

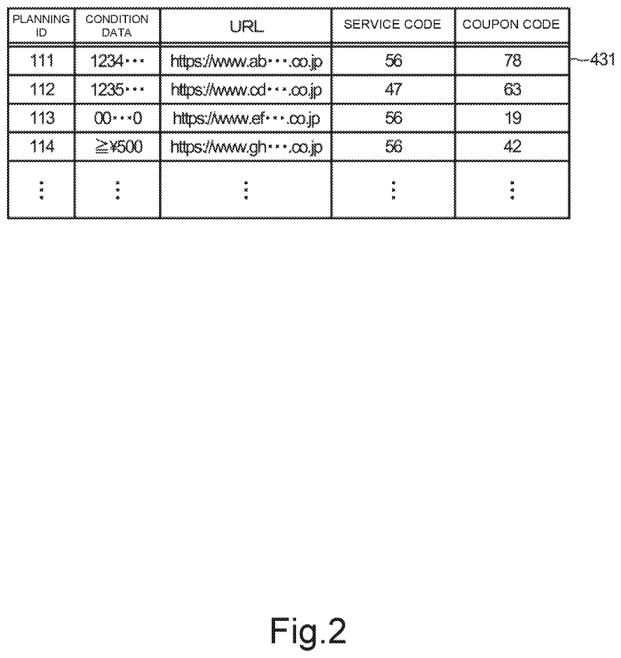

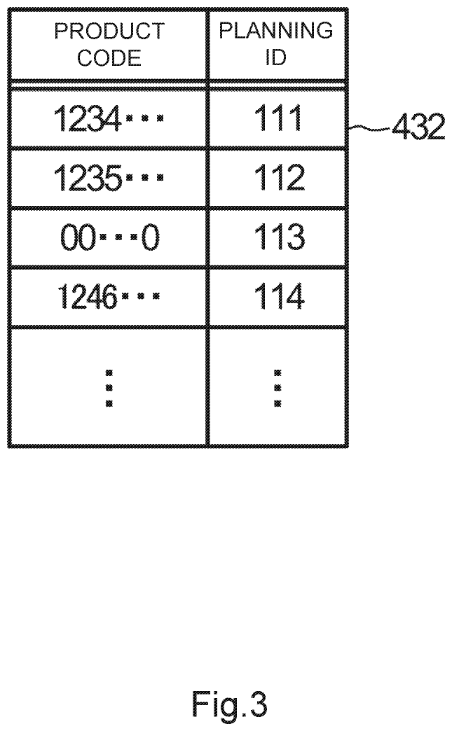

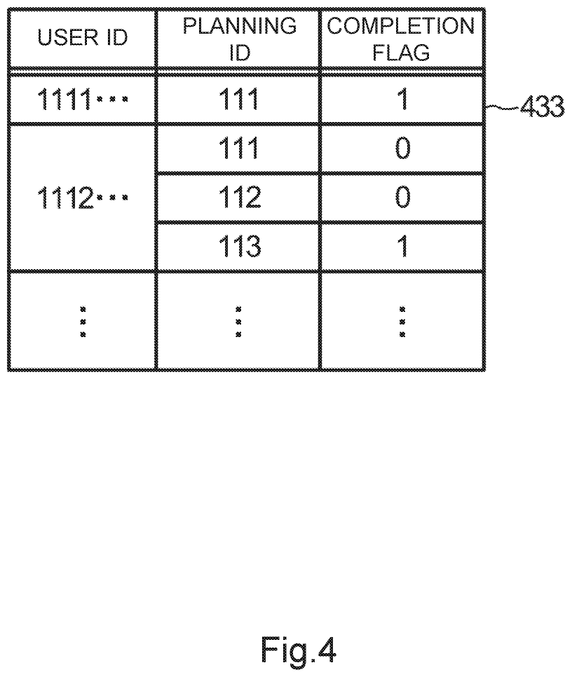

The auxiliary storage device 43 stores, for example, an issuing condition management database 431 (FIG. 2), a use condition management database 432 (FIG. 3), and an achievement status management database 433 (FIG. 4).

As shown in FIG. 2, the issuing condition management database 431 is a third storage unit that stores condition data indicating a condition for issuing a planning receipt and linked-destination information indicating a linked destination, in association with the planning ID for identifying reward providing planning. The condition data is, for example, a product code of a target product or the total amount of a product to be purchased. The linked-destination information is, for example, a URL of a web page relating to reward planning such as a questionnaire. The issuing condition management database 431 further stores a service code and a coupon code in association with each of a plurality of planning IDs. As described above, the issuing condition management database 431 is a database that manages the product code, the URL, the service code, and the coupon code in association with each of the plurality of planning IDs. Details of a configuration example of the issuing condition management database 431 will be described below.

As shown in FIG. 3, the use condition management database 432 is a first storage unit that stores the planning ID in association with the product code. Details of a configuration example of the use condition management database 432 will be described below.

As shown in FIG. 4, the achievement status management database 433 is a second storage unit that stores an achievement status of a reward providing condition determined for each linked destination, in association with each of a plurality of user IDs. Details of a configuration example of the achievement status management database 433 will be described.

The communication interface 44 includes various interfaces for communicably connecting the receipt server 4 to another apparatus via a network in accordance with a predetermined communication protocol.

Note that the hardware configuration of the receipt server 4 is not limited to the above-mentioned configuration. In the receipt server 4, the above-mentioned components may be omitted or changed and a new component may be added as appropriate.

The respective units to be mounted on the above-mentioned processor 41 will be described. As shown in FIG. 1, the processor 41 includes a first acquisition unit 410, a second acquisition unit 411, a third acquisition unit 412, a determination unit 413, a fourth acquisition unit 414, an issuing unit 415, an output unit 416, a fifth acquisition unit 417, a storage control unit 418, and a sixth acquisition unit 419. The respective units to be mounted on the processor 41 can be referred to also as respective functions. It can also be said that the respective units to be mounted on the processor 41 are to be mounted on a control unit including the processor 41 and the main memory 42.

The first acquisition unit 410 acquires transaction data including at least one of at least one product code or the total amount of a product to be purchased represented by the product code, which is transmitted from the POS terminal 1. Alternatively, the first acquisition unit 410 acquires the transaction data, the user ID, and the planning ID, which are transmitted from the POS terminal 1. The user ID acquired by the first acquisition unit 410 is based on the user ID set in the two-dimensional code symbol output by the output unit 416 as described below.

The second acquisition unit 411 acquires, from the use condition management database 432 (FIG. 3) that is the first storage unit, the product code associated with the acquired planning ID that is the planning ID acquired by the first acquisition unit 410.

The third acquisition unit 412 acquires, from the achievement status management database 433 (FIG. 4) that is the second storage unit, an achievement status of a reward providing condition associated with the acquired user ID that is the user ID acquired by the first acquisition unit 410.

The determination unit 413 determines whether or not the transaction data acquired by the first acquisition unit 410 includes the product code acquired by the second acquisition unit 411. Further, the determination unit 413 determines, on the basis of the determination result and the achievement status of the reward providing condition acquired by the third acquisition unit 412, the necessity of provision of a reward to a subject corresponding to the acquired user ID acquired by the first acquisition unit 410.

In the case where the first acquisition unit 410 does not acquire the user ID and the planning ID, the fourth acquisition unit 414 acquires, from the issuing condition management database 431 (FIG. 2) that is the third storage unit, the planning ID and the linked-destination information associated with at least one of the product code or the total amount included in the transaction data acquired by the first acquisition unit 410.

The issuing unit 415 issues a user ID. The issuing means making the user ID available and includes generation, creation, editing, and the like.

The output unit 416 outputs, to the POS terminal 1, at least the two-dimensional code symbol in which the user ID issued by the issuing unit 415 and the planning ID and the URL that is linked-destination information acquired by the fourth acquisition unit 414 are set. The printing device 17 of the POS terminal 1 prints a planning receipt including this two-dimensional code symbol in addition to a normal receipt including the details of payment.

The URL set in the two-dimensional code symbol is a URL that is uniquely linked to the planning ID but is not uniquely linked to the user ID. That is, in the case where certain link planning is provided to a different user ID, the URL set in the two-dimensional code symbol is the same regardless of the user ID. In another example, the URL set in the two-dimensional code symbol may be a URL that is uniquely linked to the planning ID and also to the user ID. That is, in the case where certain link planning is provided to different user IDs, the URL set in the two-dimensional code symbol differs for each user ID. In this case, the URL set in the two-dimensional code symbol corresponds to a web page dedicated to the user ID issued by the issuing unit 415.

The fifth acquisition unit 417 acquires an achievement status of a reward providing condition in association with the user ID from the planning server 3. For example, the fifth acquisition unit 417 acquires completion notification including the user ID and the achievement status, which is transmitted from the planning server 3. The achievement status acquired by the fifth acquisition unit 417 is based on the reward planning relating to the URL set in the two-dimensional code symbol output by the output unit 416.

The storage control unit 418 stores, in association with the user ID, the achievement status acquired by the fifth acquisition unit 417 in the achievement status management database 433 (FIG. 4) that is the second storage unit of the auxiliary storage device 43.

The sixth acquisition unit 419 acquires application notification indicating that a reward has been provided to a subject, in association with the acquired planning ID and the acquired user ID acquired by the first acquisition unit 410, which are transmitted from the POS terminal 1. The storage control unit 418 deletes, in response to the acquisition of application notification by the sixth acquisition unit 419, the achievement status stored in the achievement status management database 433 (FIG. 4) in association with the acquired user ID.

Note that although the first acquisition unit 410, the second acquisition unit 411, the third acquisition unit 412, the determination unit 413, the fourth acquisition unit 414, the issuing unit 415, the output unit 416, the fifth acquisition unit 417, the storage control unit 418, and the sixth acquisition unit 419 have been described as being mounted on the processor 41 by executing a program, the present disclosure is not limited thereto. The first acquisition unit 410, the output unit 416, the fifth acquisition unit 417, and the sixth acquisition unit 419 relate to data communication between the receipt server 4 and another apparatus. For this reason, the communication interface 44 may be an example of the first acquisition unit 410, the output unit 416, the fifth acquisition unit 417, and the sixth acquisition unit 419. The first acquisition unit 410, the output unit 416, the fifth acquisition unit 417, and the sixth acquisition unit 419 may be realized by cooperation of the processor 41 and the communication interface 44 by executing a program.

Details of a configuration example of the issuing condition management database 431 will be described. FIG. 2 is a diagram illustrating the issuing condition management database 431.

As shown in FIG. 2, the issuing condition management database 431 includes a “planning ID” item, a “condition data” item, a “URL” item, a “service code” item, and a “coupon code” item.

The “planning ID” item is an item for setting the planning ID. The “condition data” item is an item for setting a condition for issuing a planning receipt, i.e., a condition for participating in reward planning. The participating condition is, for example, that a specific product has been purchased. In this case, a product code is set in the “condition data” item. Further, in the case where the participating condition is, for example, that the total amount of purchased products is equal to or larger than a predetermined amount, the condition regarding the predetermined amount is set in the “condition data” item. Note that a combination condition such as a case where a specified number of specific products have been purchased, a case where a plurality of types of specific products have been purchased, and a case where the total amount of products including a specific product is equal to or larger than a predetermined amount may be set in the “condition data” item.

The “URL” item is an item for setting a URL. The “service code” item is an item for setting a service code. The “coupon code” item is an item for setting a coupon code. Each of a plurality of planning IDs is associated with the product code, the URL, the service code, and the coupon code by the issuing condition management database 431. Since the URL is uniquely linked to the planning ID, the URL differs for each planning ID. For this reason, the content of reward planning differs for each planning ID. The reward planning relates to a product identified by a product code associated with a URL. Reward planning relating to a product may be reward planning regarding the product itself. Further, reward planning relating to a product may be reward planning regarding a product of another company which is similar to the product. Further, the reward planning may be reward planning regarding all products. In this case, the product code is set in the issuing condition management database 431 as a predetermined product code representing all products, e.g., a code that does not indicate a specific product, such as “00 . . . 0” instead of a code assigned to a specific product.

The receipt server 4 may update the issuing condition management database 431 as appropriate.

Details of a configuration example of the use condition management database 432 will be described. FIG. 3 is a diagram illustrating the use condition management database 432.

The use condition management database 432 includes a “product code” item and a “planning ID” item. The “product code” item is an item for setting a product code of a target product of provision of a reward. Note that product codes of a plurality of target products can be set in the “product code” item. The “planning ID” item is an item for setting a planning ID.

Details of a configuration example of the achievement status management database 433 will be described. FIG. 4 is a diagram illustrating the achievement status management database 433.

The achievement status management database 433 includes a “user ID” item, a “planning ID” item, and a “completion flag” item. The “user ID” item is an item for setting a user ID. The “planning ID” item is an item for setting a planning ID. The “completion flag” item is an item for setting a value indicating that a response regarding reward planning has been completed (e.g., “1”). The value indicating that a response has been completed, which is set in the “completion flag” item, corresponds to the achievement completion information included in the achievement status of completion notification. As shown in FIG. 4, a plurality of planning IDs and completion flags are set with respect to one user ID in some cases.

Note that the achievement status management database 433 may include a “response content” item. The “response content” item is an item for setting a value corresponding to the point of response content. The value set in the “response content” item corresponds to the response content information included in the response content information of completion notification.

The receipt server 4 sets a user ID in the “user ID” item every time a user ID is issued. Further, the receipt server 4 sets a value in the “completion flag” item every time completion notification is acquired. The receipt server 4 sets a value indicating that a response has been completed in the “completion flag” item on the basis of the achievement completion information extracted from the achievement status of completion notification. In the case where the achievement status management database 433 includes a “response content” item, the receipt server 4 sets the response content information extracted from the achievement status of completion notification in the “response content” item.

Each of the plurality of user IDs is associated with the achievement status by the achievement status management database 433. The receipt server 4 may update the achievement status management database 433 by adding a record to the achievement status management database 433 in response to acquisition of completion notification from the planning server 3.

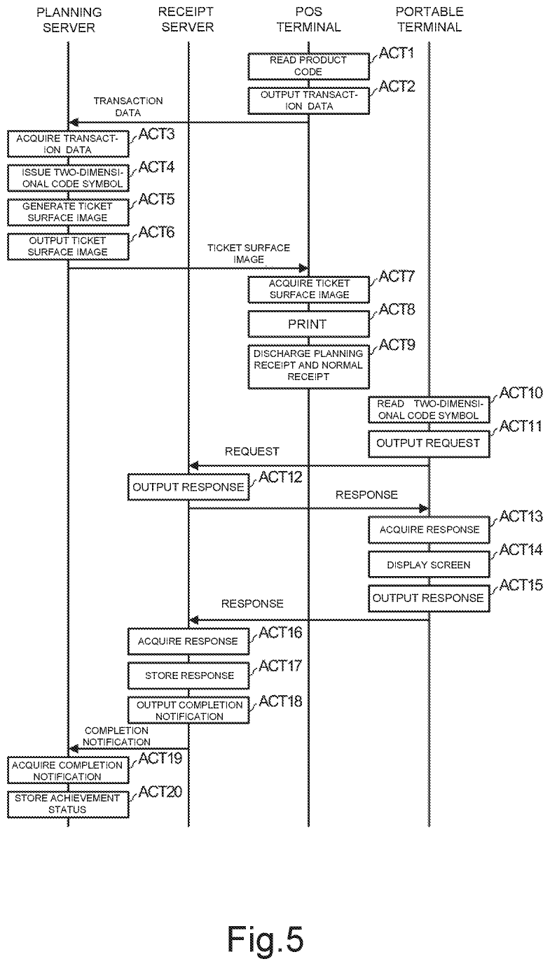

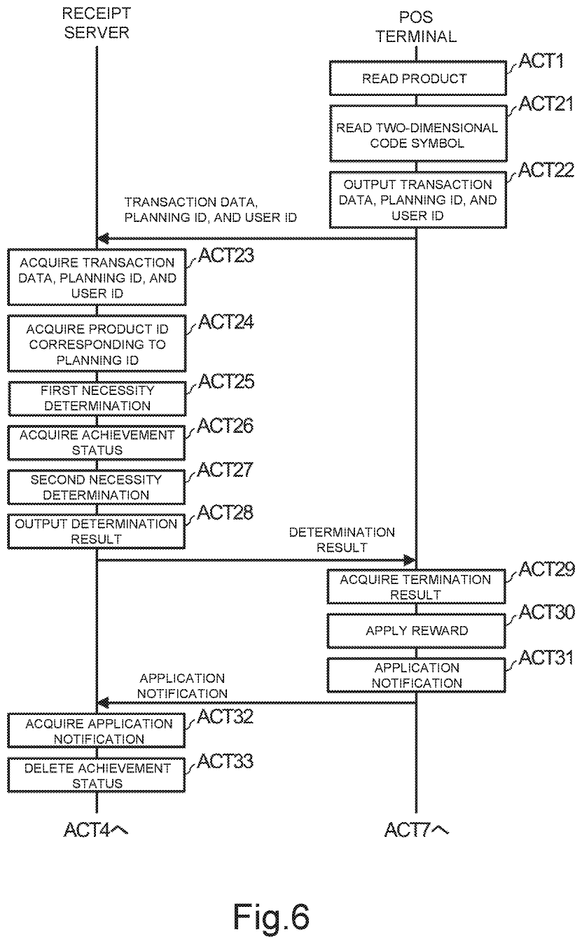

A procedure of processing executed by the information processing system 100 will be described. FIG. 5 and FIG. 6 are each a sequence diagram illustrating a procedure of reward providing processing executed by the information processing system 100. Note that in the following description mainly on the POS terminal 1, the POS terminal 1 may be replaced with the processor 11. Similarly, in the description mainly on the portable terminal 2, the portable terminal 2 may be replaced with the processor 21. In the description mainly on the planning server 3, the planning server 3 may be replaced with the processor 31. In the description mainly on the receipt server 4, the receipt server 4 may be replaced with the processor 41.

FIG. 5 shows a procedure of the processing in a situation where a consumer has not received a planning receipt. Here, the consumer having the portable terminal 2 is referred to as the consumer X. Assumption is made that the consumer X purchases a product corresponding to the product code “1234 . . . ” shown in FIG. 2.

As shown in FIG. 5, in ACT1, the POS terminal 1 reads a product code. In ACT1, for example, the registration unit 110 of the POS terminal 1 reads, by the reading device 18, a product code from a code symbol attached to one or more products to be purchased by the consumer X in one transaction. The registration unit 110 then registers the read product code in the product-to-be-purchased register provided in the main memory 12 or the auxiliary storage device 13.

In ACT2, the POS terminal 1 outputs transaction data. In ACT2, for example, the POS terminal 1 outputs the transaction data to the receipt server 4 via the communication interface 14. The transaction data includes a product code regarding one or more products to be purchased by the consumer X in one transaction, the number of purchases and the subtotal amount of each product, and the total amount of the transaction. The POS terminal 1 may output the product code to the receipt server 4 after completing the payment of one transaction by the consumer X. Here, as an example, assumption is made that the POS terminal 1 outputs the transaction data including a product code “1234 . . . ” to the receipt server 4. Note that in the case where the consumer X purchases a plurality of products, the POS terminal 1 outputs transaction data including a plurality of product codes to the receipt server 4.

As shown in FIG. 5, in ACT3, the first acquisition unit 410 of the receipt server 4 acquires the transaction data. In ACT3, for example, the first acquisition unit 410 acquires the transaction data including the product code “1234 . . . ” from the POS terminal 1 via the communication interface 44.

In ACT4, the receipt server 4 issues a two-dimensional code symbol on the basis of the transaction data acquired by the first acquisition unit 410. In ACT4, for example, the fourth acquisition unit 414 acquires, from the issuing condition management database 431 (FIG. 2), a planning ID “111”, a URL, a service code “56”, and a coupon code “78” associated with the product code “1234 . . . ” included in the transaction data. As described above, the fourth acquisition unit 414 acquire reward planning relating to the product purchased by the consumer X. Hereinafter, the reward planning corresponding to the planning ID “111” will be referred to also as target reward planning. As a result, the receipt server 4 prevents unnecessary reward planning from being provided to the consumer X.

Further, in ACT4, the issuing unit 415 issues a user ID. For example, the issuing unit 415 issues a user ID relating to the planning ID “111”. Here, assumption is made that the issuing unit 415 issues a user ID “1111 . . . ”. Note that the user ID only needs to be an individual ID for uniquely identifying the combination of reward planning and each person as described above, and is not limited. For example, the issuing unit 415 may issue a user ID by adding a different number after the number of the planning ID “111” for each timing of issuing a user ID relating to the planning ID “111”. In this example, the processor 41 is capable of detecting the planning ID from the user ID. The issuing unit 415 adds a new record to the achievement status management database 433 by setting a user ID “1111 . . . ” in the “user ID” item of the achievement status management database 433 (FIG. 4) and setting the planning ID “111” in the “planning ID” item. Note that the issuing unit 415 sets a value “0” indicating that a response has not been completed in the “completion flag” item of the record to be newly added to the achievement status management database 433. In this way, the issuing unit 415 issues a user ID for uniquely identifying the combination of reward planning and each person. As a result, the receipt server 4 manages the achievement status for each reward planning of each person without requiring a complicated configuration such as managing personal information of each person.

The issuing unit 415 then issues a two-dimensional code symbol in which the acquired planning ID, URL, service code, and coupon code, and the issued user ID are set. For example, the user ID “1111 . . . ”, the planning ID “111”, the service code “56”, and the coupon code “78” are set as query parameters followed by a URL “http://www. . . . .co.jp”. Specifically, for example, a character string of “http://www. . . . .co.jp?uid=1111 . . . &deli_id=111&deli_type=56&coupon_code=78” is set in the two-dimensional code symbol.

Note that in the case where one product code transmitted from the POS terminal 1 corresponds to the product code of each of a plurality of planning IDs, the issuing unit 415 issues, for each planning ID, a two-dimensional code symbol in which the same user ID, a URL, a service code, and a coupon code are set. Further, in the case where a plurality of product codes is transmitted from the POS terminal 1, the issuing unit 415 issues a two-dimensional code symbol in the same manner for each of the product codes.

As shown in FIG. 5, in ACT5, the output unit 416 of the receipt server 4 generates a ticket surface image. In ACT5, the output unit 416 generates, as a ticket surface image to be printed on a planning receipt, an image of the issued two-dimensional code symbol and an image regarding target reward planning such as a message and a picture. For example, in the case where the target reward planning is a questionnaire, the message includes a sentence indicating the content of reward planning such as “Product XX is 100 yen off by answering the questionnaire”. Further, the message includes, for example, a sentence indicating how to obtain a reward such as “Please read the two-dimensional code to access the web page, and answer the questionnaire”.

In ACT6, the output unit 416 further outputs the ticket surface image. In ACT6, for example, the output unit 416 outputs, via the communication interface 44, the ticket surface image generated in the ACT5 described above to the POS terminal 1.

As shown in FIG. 5, in ACT7, the POS terminal 1 acquires the ticket surface image. In ACT7, for example, the POS terminal 1 acquires, via the communication interface 14, the ticket surface image from the receipt server 4.

In ACT8, the POS terminal 1 prints the ticket surface image. In ACT8, for example, the POS terminal 1 prints the ticket surface image on a receipt paper by the printing device 17. The ticket surface image includes a two-dimensional code symbol and an image regarding target reward planning. The receipt on which the ticket surface image is printed is referred to also as a planning receipt. Further, the POS terminal 1 prints details of payment on the receipt paper by the printing device 17. The receipt on which details of payment is printed is referred to also as a normal receipt. The POS terminal 1 prints a plurality of planning receipts in some cases.

In ACT9, the POS terminal 1 discharges the planning receipt and the normal receipt. In ACT9, for example, the POS terminal 1 discharges the planning receipt and the normal receipt from a receipt outlet. The consumer X can receive the planning receipt and the normal receipt discharged from the POS terminal 1.

As shown in FIG. 5, in ACT10, the portable terminal 2 reads a two-dimensional code symbol. In ACT10, for example, the portable terminal 2 reads, by the reading device 27, a two-dimensional code symbol printed on the planning receipt. Here, assumption is made that the consumer X holds the two-dimensional code symbol printed on the planning receipt over the reading device 27.

In ACT11, the portable terminal 2 outputs a request for a web page regarding the target reward planning. In ACT11, for example, the portable terminal 2 acquires the planning ID “111”, the URL, the service code “56”, the coupon code “78”, and the user ID “1111 . . . ” set in the two-dimensional code symbol in response to the reading of a two-dimensional code symbol by the reading device 27. The portable terminal 2 accesses the planning server 3 of the corresponding URL via the communication interface 14, and outputs a request for a web page regarding the target reward planning. The request includes the acquired planning ID “111” and user ID “1111 . . . ”.

As shown in FIG. 5, in ACT12, the planning server 3 outputs a web page regarding the target reward planning in response to the request for a web page regarding the target reward planning. In ACT12, for example, the planning server outputs a web page regarding the target reward planning such as a questionnaire via the communication interface 34. The target reward planning can be specified by the planning ID “111”. That is, in the case where the planning server 3 provides a plurality of types of reward planning, the planning server 3 sorts the individual types of reward planning by the planning ID. Further, at this time, the planning server 3 creates, in the auxiliary storage device 33, a response storage area for accumulating responses to target reward planning such as an answer to a questionnaire from the portable terminal 2 in association with the planning ID “111” and the user ID “1111 . . . ”.

As shown in FIG. 5, in ACT13, the portable terminal 2 acquires the web page regarding the target reward planning. In ACT13, for example, the portable terminal 2 acquires, from the planning server 3, the web page regarding the target reward planning via the communication interface 14.

In ACT14, the portable terminal 2 displays a screen of the web page regarding the target reward planning. In ACT14, the portable terminal 2 displays, on the display device 26, a screen of the web page regarding the target reward planning.

In ACT15, the portable terminal 2 outputs a response such as an answer to a questionnaire. In ACT15, for example, the portable terminal 2 outputs, via the communication interface 24, a response to the planning server 3. Assumption is made that the consumer X inputs, by the input device 25, an answer to a questionnaire on a screen of a webpage regarding the target reward planning, browses a campaign screen, or views an advertisement movie. In the case where a specified reward providing condition such as an operation transmitting an answer to a questionnaire, an operation browsing a campaign screen to the end, and viewing of an advertisement movie to the end is satisfied, the portable terminal 2 outputs a response.

As shown in FIG. 5, in ACT16, the planning server 3 acquires the response. In ACT16, for example, the planning server 3 acquires, via the communication interface 34, the response from the portable terminal 2.

In ACT17, the planning server 3 stores the acquired response in the auxiliary storage device 33. In ACT17, for example, the planning server 3 stores, in the response storage area for accumulating responses created in the auxiliary storage device 33, the response in association with the planning ID “111” and the user ID “1111 . . . ” (see ACT12). In this way, the planning server 3 stores, in the auxiliary storage device 33, the answer that is a response in association with the questionnaire that is target reward planning. In the case where the target reward planning is browsing of a campaign screen or viewing of an advertisement movie, the number of responses may be stored.

In ACT18, the planning server 3 outputs completion notification. In ACT18, for example, the planning server 3 outputs, via the communication interface 34, completion notification to the receipt server 4 in response to the acquisition of the response described above. The completion notification includes the user ID “1111 . . . ”. The completion notification includes the achievement status of a reward providing condition. The achievement status includes achievement completion information to target reward planning. The achievement status may include response content information to target reward planning. Note that after outputting the completion notification, the planning server 3 may delete the user ID “1111 . . . ” stored in the response storage area of the auxiliary storage device 33. This is because a company or the like that is a planner of target reward planning needs response content such as a questionnaire result, the number of browses, and the number of views, and does not need the user ID itself, which is information that cannot specify the individual.

As shown in FIG. 5, in ACT19, the fifth acquisition unit 417 of the receipt server 4 acquires the completion notification. In ACT19, for example, the fifth acquisition unit 417 acquires, via the communication interface 44, the completion notification including an achievement status.

As shown in FIG. 5, in ACT20, the storage control unit 418 of the receipt server 4 stores, in the auxiliary storage device 43, the completion notification acquired by the fifth acquisition unit 417 in association with the user ID. In ACT20, for example, the storage control unit 418 sets the “completion flag” item in the achievement status management database 433 (FIG. 4). That is, the storage control unit 418 sets, in the “completion flag” item, a value “1” indicating that a response has been completed in association with the user ID “1111 . . . ”, on the basis of the achievement status of completion notification. Note that in the case where the acquired achievement status includes the achievement completion information, the storage control unit 418 sets, in the “response content” item, a value in the achievement status management database 433. That is, the storage control unit 418 sets, in the “response content” item, a value corresponding to the point of the response content in association with the user ID “1111 . . . ”, on the basis of the achievement status of completion notification.

FIG. 6 shows a procedure of the processing in a situation where a two-dimensional code symbol of a planning receipt has been read and the consumer X has responded to reward planning. Here, assumption is made that the consumer X purchases a product corresponding to the product code “1234 . . . ” again. That is, a case where a target product set as an issuing condition of a planning receipt and a target product of a reward use condition are the same will be described as an example. Note that it goes without saying that the target products may be different from each other.

As shown in FIG. 6, in ACT1, the POS terminal 1 reads a product code. This ACT1 in FIG. 6 is as described for ACT1 in FIG. 5.

As shown in FIG. 6, in ACT21, the first acquisition unit 111 of the POS terminal 1 reads a two-dimensional code symbol. In ACT21, for example, the first acquisition unit 111 reads, by the reading device 18, a two-dimensional code symbol printed on a planning receipt. Here, assumption is made that the consumer X or a sales clerk holds a two-dimensional code symbol printed on a planning receipt over the reading device 18. For example, the consumer X or a sales clerk holds a two-dimensional code symbol over the reading device 18 when the consumer X comes back to the store the next day of the day when receiving a planning receipt. The first acquisition unit 111 acquires the URL, the user ID “1111 . . . ”, the planning ID “111”, the service code “56”, and the coupon code “78” set in the two-dimensional code symbol in response to the reading of the two-dimensional code symbol by the reading device 18, and temporarily stores them in the main memory 12 or the auxiliary storage device 13.

In ACT22, the output unit 112 of the POS terminal 1 outputs transaction data, a planning ID, and a user ID. In ACT22, for example, the output unit 112 outputs, via the communication interface 14, transaction data including the product code “1234 . . . ” registered in the ACT1 described above, and the planning ID “111” and the user ID “1111 . . . ” of the temporarily stored data described above to the receipt server 4. Note that in the case where the consumer X purchases a plurality of products, the POS terminal 1 outputs transaction data including a plurality of product codes to the receipt server 4. Further, in the case where a plurality of URLs and query parameters are set in the two-dimensional code symbol of the planning receipt, the POS terminal 1 outputs a plurality of planning IDs and user IDs to the receipt server 4.

As shown in FIG. 6, in ACT23, the first acquisition unit 410 of the receipt server 4 acquires the transaction data including a product code, the planning ID, and the user ID. In ACT23, for example, the first acquisition unit 410 acquires, via the communication interface 44, the transaction data including the product code “1234 . . . ”, the planning ID “111”, and the user ID “1111 . . . ” from the POS terminal 1.

In ACT24, the second acquisition unit 411 of the receipt server 4 acquires a product code corresponding to the planning ID. In ACT24, for example, the second acquisition unit 411 refers to the use condition management database 432 (FIG. 3). The second acquisition unit 411 acquires a value “1234 . . . ” set in the “product code” item associated with the planning ID “111” acquired by the first acquisition unit 410.

In ACT25, the determination unit 413 of the receipt server 4 performs first reward necessity determination. In ACT25, for example, the determination unit 413 determines the necessity of provision of a reward to a subject corresponding to the user ID “1111 . . . ” acquired by the first acquisition unit 410 on the basis of the product code acquired by the second acquisition unit 411.

Specifically, the determination unit 413 determines the necessity of provision of a reward on the basis of whether or not the product code included in the transaction data acquired by the first acquisition unit 410 is included in the product code acquired by the second acquisition unit 411. For example, in the case where the first acquisition unit 410 acquires the transaction data including the product code “1234 . . . ” and the planning ID “111”, the second acquisition unit 411 acquires the product code “1234 . . . ” associated with the planning ID “111”, and therefore, the determination unit 413 determines that a reward needs to be provided. For example, when the first acquisition unit 410 acquires the transaction data including the product code “1234 . . . ” and a planning ID “113”, the product code associated with the planning ID “113” acquired by the second acquisition unit 411 is “00 . . . 0”. In this case, since the product code “00 . . . 0” is a product code representing all products, the product code “1234 . . . ” included in the transaction data acquired by the first acquisition unit 410 is included in the product code acquired by the second acquisition unit 411 and therefore, the determination unit 413 determines that a reward needs to be provided. As described above, the determination unit 413 determines the necessity of provision of a reward in accordance with whether or not the product code of a product to be purchased by the consumer X is included in the product code corresponding to the target reward planning. That is, the determination unit 413 determines, in the case where the consumer X purchases a product indicated by a product code corresponding to target reward planning, that a reward needs to be provided.

In ACT26, the third acquisition unit 412 of the receipt server 4 acquires, from the auxiliary storage device 43, an achievement status associated with the user ID included in the transaction data acquired by the first acquisition unit 410. In ACT26, for example, the third acquisition unit 412 refers to the achievement status management database 433 (FIG. 4). The third acquisition unit 412 acquires a value set in the “completion flag” item associated with the user ID “1111 . . . ” and the planning ID “111”, which is “1” in this example.

In ACT27, the determination unit 413 of the receipt server 4 performs second reward necessity determination. In ACT27, for example, the determination unit 413 determines, on the basis of the achievement status acquired by the third acquisition unit 412, the necessity of provision of a reward to a subject corresponding to the user ID included in the transaction data acquired by the first acquisition unit 410.

Specifically, the determination unit 413 refers to the value set in the “completion flag” item associated with the user ID “1111 . . . ” and the planning ID “111”, for example. For example, the determination unit 413 determines the necessity of provision of a reward on the basis of whether or not the value “1” indicating that a response has been completed is set in the “completion flag” item. In this example, for example, a company planning a questionnaire regarding its own products as reward planning is capable of setting provision of a reward relating to the own products to a consumer who has answered the questionnaire. In the case where a value indicating that a response has been completed is set in the “completion flag”, the determination unit 413 determines that a reward needs to be provided to a subject corresponding to the user ID “1111 . . . ”. In the case where a value “1” indicating that a response has been completed is not set in the “completion flag” item, the determination unit 413 determines that a reward does not need to be provided to a subject corresponding to the user ID “1111 . . . ”. As described above, the determination unit 413 determines the necessity of provision of a reward on the basis whether or not there is a response to target reward planning.

Further, in the case where the achievement status management database 433 includes the “response content” item, the determination unit 413 determines the necessity of provision of a reward in accordance with the value corresponding to the point of the response content set in the “response content” item, for example. In this example, a company planning a questionnaire regarding its own products as reward planning is capable of setting provision of a reward relating to the own products to a consumer who has rated the own products high. In the case where the value set in the “response content” item is equal to or larger than a reference value, the determination unit 413 determines that a reward needs to be provided. In the case where the value set in the “response content” item is less than the reference value, the determination unit 413 determines that a reward does not need to be provided. Further, conversely, a company planning a questionnaire regarding a different company's products is capable of setting provision of a reward relating to its own products to a consumer who has evaluated the different company's products low. In the case where the value set in the “response content” item is equal to or larger than the reference value, the determination unit 413 determines that a reward does not need to be provided. In the case where the value set in the “response content” item is less than the reference value, the determination unit 413 determines that a reward needs to be provided. As described above, the determination unit 413 determines the necessity of provision of a reward in accordance with the response content to target reward planning. Note that the reference value may be changeable. The reference value may differ for each questionnaire.

As described above, the determination unit 413 refers to the achievement status associated with the user ID, and determines the necessity of provision of a reward to a subject corresponding to this user ID. As a result, the receipt server 4 determines the necessity of provision of a reward without requiring a complicated configuration such as managing personal information of each person. Further, the receipt server 4 determines a consumer appropriate for provision of a reward by referring to the achievement status.

In ACT28, the determination unit 413 outputs the final determination result based on the determination result in ACT25 and the determination result in ACT27. In ACT28, for example, the determination unit 413 determines, in the case where both the determination result in ACT25 and the determination result in ACT27 indicate that a reward needs to be provided, that a reward needs to be provided to a subject. In other cases, the determination unit 413 determines that a reward does not need to be provided to a subject. The determination unit 413 outputs, via the communication interface 44, this determination result to the POS terminal 1. As described above, the determination unit 413 outputs a determination result indicating the necessity of a reward in response to the reading of a two-dimensional code symbol in a store. As a result, the receipt server 4 motivates the consumer X for the next visit.

As shown in FIG. 6, in ACT29, the second acquisition unit 113 of the POS terminal 1 acquires the determination result. In ACT29, for example, the second acquisition unit 113 acquires, via the communication interface 14, the determination result from the receipt server 4.

In ACT30, the application unit 114 of the POS terminal 1 applies a reward to a subject. In ACT30, for example, the application unit 114 applies a reward when the acquired determination result indicates that a reward needs to be provided. In this case, the application unit 114 applies a reward indicated by the coupon code “78” that is acquired from a two-dimensional code symbol of a planning receipt and temporarily stored in ACT21. For example, the application unit 114 makes a discount for the amount of the product indicated by the product code “1234 . . . ”. As described above, the POS terminal 1 stores, in the auxiliary storage device 13, the content of a reward in association with the compound code, e.g., what subtotal discount is to be made for which product, what discount is to be made for the total amount, or how many points are to be given. Therefore, there is no need to notify the POS terminal 1 of the content of a reward from the receipt server 4.

In ACT31, the application unit 114 further outputs application notification. In ACT31, for example, the application unit 114 outputs, via the communication interface 14, application notification indicating that a reward has been provided to a subject in association with the planning ID “111” and the user ID “1111 . . . ” of the temporarily-stored data described above to the receipt server 4. After that, the processing of the POS terminal 1 proceeds to the processing of the ACT7 described above.

As shown in FIG. 6, in ACT32, the sixth acquisition unit 419 of the receipt server 4 acquires the application notification. In ACT32, for example, the sixth acquisition unit 419 acquires, via the communication interface 44, the application notification associated with the planning ID and the user ID from the POS terminal 1.

In ACT33, the storage control unit 418 of the receipt server 4 deletes the achievement status stored in the auxiliary storage device 43 in association with the planning ID and the user ID. In ACT33, for example, the storage control unit 418 deletes the record corresponding to the planning ID “111” and the user ID “1111 . . . ” in the achievement status management database 433 (FIG. 4). Note that in the case where a plurality of planning IDs and completion flags are registered with respect to one user ID in the achievement status management database 433, the storage control unit 418 deletes the corresponding planning IDs and completion flags. After that, the processing of the receipt server 4 proceeds to the processing of the ACT4 described above.

Note that in ACT6 in FIG. 6, the output unit 416 outputs a ticket surface image to the POS terminal 1, but the present disclosure is not limited thereto. The output unit 416 may output a ticket surface image including an image of a two-dimensional code symbol to the portable terminal 2. In this example, the processing of ACT7 is omitted, and only printing and discharging of a normal receipt are performed in ACT8 and ACT9. In ACT10, the portable terminal 2 reads the two-dimensional code symbol stored in the terminal itself. In ACT21, the POS terminal 1 reads, by the reading device 18, a two-dimensional code symbol displayed on the display device 26 of the portable terminal 2. This eliminates, for example, the necessity for the consumer X to carry a planning receipt, and thus, the receipt server 4 assists the consumer X in easily managing a code symbol.

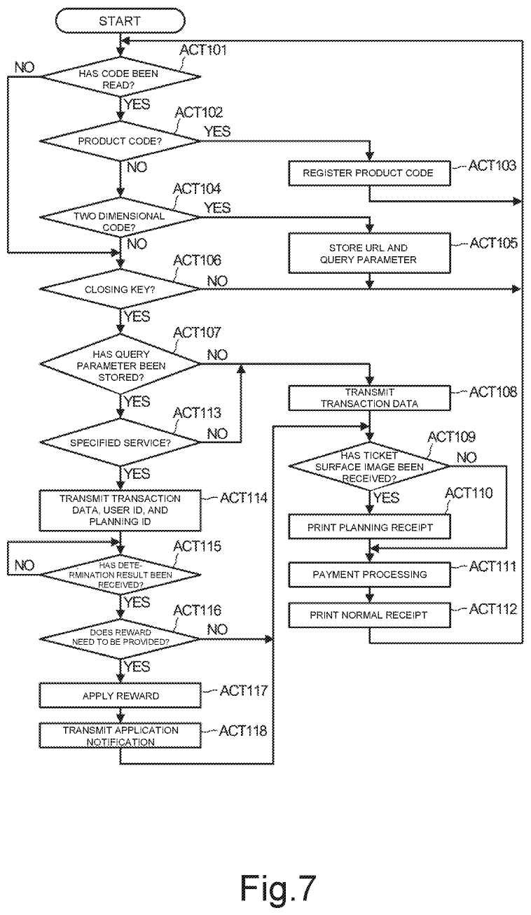

FIG. 7 is a flowchart illustrating information processing executed by the processor 11 of the POS terminal 1 in order to realize a procedure of the reward providing processing as shown in FIG. 5 and FIG. 6.

As shown in FIG. 7, in ACT101, the processor 11 determines whether or not a code symbol attached to a product or a two-dimensional code symbol printed on a planning receipt has been read by the reading device 18. In the case where a code symbol has not been read (NO in ACT101), the processing of the processor 11 proceeds to ACT106. Further, in the case where a code symbol has been read (YES in ACT1), the processing of the processor 11 proceeds to ACT102.

In ACT102, the processor 11 determines whether or not the read code symbol is a code symbol in which a product code has been set. In the case where a code symbol in which a product code has been set has not been read (NO in ACT102), the processing of the processor 11 proceeds to ACT104. Further, in the case where a code symbol in which a product code has been set has been read (YES in ACT102), the processing of the processor 11 proceeds to ACT103.

In ACT103, the processor 11 registers the read product code in the product-to-be-purchased register provided in the main memory 12 or the auxiliary storage device 13. The processing of the processor 11 proceeds to the ACT101 described above.

The processing of ACT101 to ACT103 described above corresponds to the processing procedure of ACT1 in FIG. 5 and FIG. 6.

In ACT104, the processor 11 determines whether or not the read code symbol is a two-dimensional code symbol. In the case where a two-dimensional code symbol has not been read (NO in ACT104), the processing of the processor 11 proceeds to ACT106. Further, in the case where a two-dimensional code symbol has been read (YES in ACT104), the processing of the processor 11 proceeds to ACT105.

In ACT105, the processor 11 temporarily stores, in the main memory 12 or the auxiliary storage device 13, the URL read from the two-dimensional code symbol, and the query parameters, i.e., the user ID, the planning ID, the service code, and the coupon code. After that, the processing of the processor 11 proceeds to the ACT101 described above.

The processing of ACT101, ACT102, ACT104, and ACT105 described above corresponds to the processing procedure of ACT21 in FIG. 6.

In ACT106, the processor 11 determines whether or not a closing key of the input device 15 has been operated. In the case where the closing key has not been operated (NO in ACT106), the processing of the processor 11 proceeds to ACT101. Further, in the case where the closing key has been operated (YES in ACT106), the processing of the processor 11 proceeds to ACT107.

In ACT107, the processor 11 determines whether or not a query parameter has been stored in the main memory 12 or the auxiliary storage device 13. In the case where a query parameter has been stored (YES in ACT107), the processing of the processor 11 proceeds to ACT113. Further, in the case where a query parameter has not been stored (NO in ACT107), the processing of the processor 11 proceeds to ACT108.

In ACT108, the processor 11 transmits, via the communication interface 14, the transaction data to the receipt server 4. This processing of ACT108 corresponds to the processing procedure of ACT2 in FIG. 5. After that, the processing of the processor 11 proceeds to ACT109.

In ACT109, the processor 11 determines whether or not a ticket surface image has been received from the receipt server 4 via the communication interface 14. For example, in the case where a ticket surface image has not been received within a specified period of time (NO in ACT109), the processing of the processor 11 proceeds to ACT111. Alternatively, by adopting such a specification that notification of no ticket surface image is returned to the POS terminal 1 in the case where a ticket surface image corresponding to a product code cannot be created in the receipt server 4, the processing of the processor 11 may proceed to ACT111 when the notification is received (NO in ACT109). Further, in the case where a ticket surface image has been received (YES in ACT109), the processing of the processor 11 proceeds to ACT110. The case where a ticket surface image has been received corresponds to the processing procedure of ACT7 in FIG. 5.

In ACT110, the processor 11 prints and discharges a planning receipt having a ticket surface image by the printing device 17. After that, the processing of the processor 11 proceeds to ACT111.

In ACT111, the processor 11 executes payment processing of a product to be purchased. After that, the processing of the processor 11 proceeds to ACT112.

In ACT112, the processor 11 prints and discharges a normal receipt having details of payment. After that, the processing of the processor 11 proceeds to ACT101.

The processing of ACT110 and ACT112 described above corresponds to the processing procedure of ACT8 and ACT9 in FIG. 5.

In ACT113, the processor 11 determines whether or not the service code of the query parameters (ACT105) temporarily stored in the main memory 12 or the auxiliary storage device 13 indicates a specified service type such as a questionnaire. The specified service type is stored in the auxiliary storage device 13 in advance. As described above, whether or not the service specified by the specific service code can be received in the store can be set for each store. In the case where the service code of the query parameters described above (ACT105) is not a service code of a specified service type (NO in ACT113), the processing of the processor 11 proceeds to ACT108. For example, in the case where the store does not support the service providing a reward to a subject who has answered a questionnaire, the processing of the processor 11 proceeds to ACT108 regardless of the planning ID and the like in the case of the service code indicating the service type of a questionnaire. In the case where the service code of the query parameters described above (ACT105) is a service code of the specified service type (YES in ACT113), the processing of the processor 11 proceeds to ACT114.

In ACT114, the processor 11 transmits, via the communication interface 14, the transaction data, and the planning ID and user ID of the temporarily-stored query parameters to the receipt server 4. The processing of ACT114 corresponds to the processing procedure of ACT22 in FIG. 6. After that, the processing of the processor 11 proceeds to ACT115.

In ACT115, the processor 11 stands by for receiving a determination result from the receipt server 4 via the communication interface 14. In the case where a determination result has been received (YES in ACT115), the processing of the processor 11 proceeds to ACT116. This processing of determining that a determination result has been received (YES in ACT115) corresponds to the processing procedure of ACT29 in FIG. 6.

In ACT116, the processor 11 determines whether or not the received determination result described above indicates that a reward needs to be provided. In the case where the received determination result indicates that a reward does not need to be provided (NO in ACT116), the processing of the processor 11 proceeds to ACT109. In the case where the received determination result indicates that a reward needs to be provided (YES in ACT116), the processing of the processor 11 proceeds to ACT117.

In ACT117, the processor 11 applies a reward to a subject. After that, the processing of the processor 11 proceeds to ACT118.

The processing of ACT116 and ACT117 described above corresponds to the processing procedure of ACT30 in FIG. 6.

In ACT118, the processor 11 transmits, via the communication interface 14, the application notification in association with the planning ID and the user ID to the receipt server 4. After that, the processing of the processor 11 proceeds to ACT109. This processing of ACT118 corresponds to the processing procedure of ACT31 in FIG. 6.

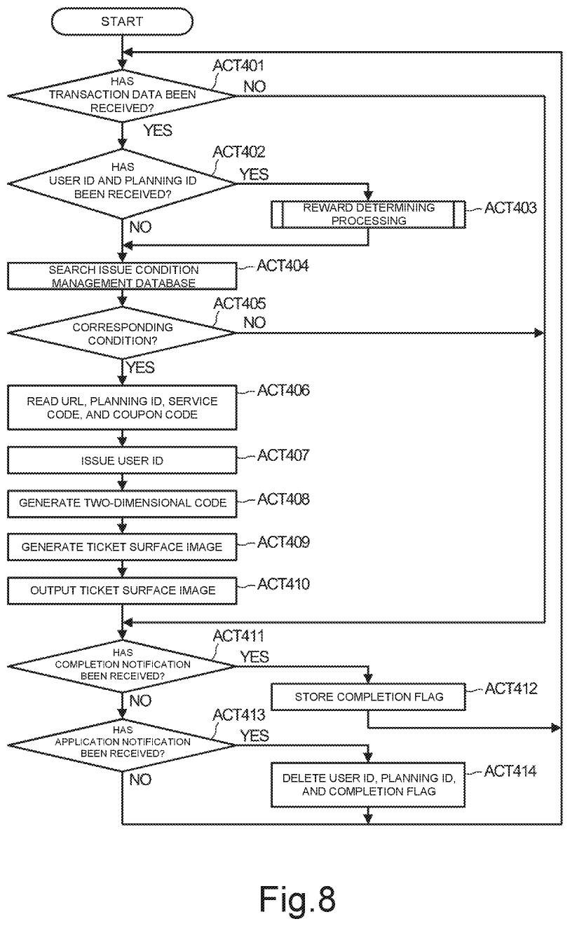

FIG. 8 is flowchart illustrating information processing executed by the processor 41 of the receipt server 4 in order to realize a procedure of the reward providing processing as shown in FIG. 5 and FIG. 6.

In ACT401, the processor 41 determines whether or not transaction data has been received from the POS terminal 1 via the communication interface 44. In the case where transaction data has not been received (NO in ACT401), the processing of the processor 41 proceeds to ACT410. In the case where transaction data has been received (YES in ACT401), the processing of the processor 41 proceeds to ACT402.

In ACT402, the processor 41 determines whether or not also the user ID and the planning ID have been further received from the POS terminal 1 via the communication interface 44. In the case where also the user ID and the planning ID have been received (YES in ACT402), the processing of the processor 41 proceeds to ACT403. The processing of ACT401 and the processing of determining that the user ID and the planning ID have been received (YES in ACT402) correspond to the processing procedure of ACT23 in FIG. 6. In the case where the user ID and the planning ID have not been received (NO in ACT402), the processing of the processor 41 proceeds to ACT404. The processing of ACT401 and the processing of determining that the user ID and the planning ID have not been received (NO in ACT402) correspond to the processing procedure of ACT3 in FIG. 5.

In ACT403, the processor 41 executes reward determining processing. This reward determining processing will be described below. After that, the processing of the processor 41 proceeds to ACT404.

In ACT404, the processor 41 searches the issuing condition management database 431 (FIG. 2) in the auxiliary storage device 43 using the product code or the total amount included in the received transaction data described above. After that, the processing of the processor 41 proceeds to ACT405.

In ACT405, the processor 41 determines whether or not a product code corresponding to the product code included in the received transaction data has been in the issuing condition management database 431. Alternatively, the processor 41 determines whether or not a condition regarding the total amount corresponding to the total amount included in the received transaction data has been in the issuing condition management database 431. In the case where the corresponding condition regarding the product code or the total amount has not been in the issuing condition management database 431 (NO in ACT405), the processing of the processor 41 proceeds to ACT401. In the case where the corresponding condition regarding the product code or the total amount has been in the issuing condition management database 431 (YES in ACT405), the processing of the processor 41 proceeds to ACT406.

In ACT406, the processor 41 reads, from the issuing condition management database 431, the URL, the planning ID, the service code, and the coupon code associated with the corresponding condition regarding the product code or the total amount. After that, the processing of the processor 41 proceeds to ACT407.

In ACT407, the processor 41 issues a user ID. Further, the processor 41 addas a new record to the achievement status management database 433. The processor 41 then sets, in the added record, the issued user ID described above, the planning ID read in ACT406, and a value “0” of a completion flag indicating that a response has not been completed. After that, the processing of the processor 41 proceeds to ACT408.

In ACT408, the processor 41 generates a two-dimensional code symbol in which the URL, the planning ID, the service code, and the coupon code read in ACT406 and the user ID issued in ACT407 are set. After that, the processing of the processor 41 proceeds to ACT409.

The processing of ACT106 to ACT408 described above corresponds to the processing procedure of ACT4 in FIG. 5.

In ACT409, the processor 41 generates a ticket surface image including an image of the two-dimensional code symbol generated in ACT409 and an image regarding target reward planning such as a message and a picture. This processing of ACT409 corresponds to the processing procedure of ACT5 in FIG. 5. After that, the processing of the processor 41 proceeds to ACT410.

In ACT410, the processor 41 outputs, via the communication interface 44, the ticket surface image generated in ACT409 to the POS terminal 1. This processing of ACT410 corresponds to the processing procedure of ACT6 in FIG. 5. After that, the processing of the processor 41 proceeds to ACT411.

In ACT411, the processor 41 determines whether or not completion notification including an achievement status in association with the user ID has been received from the planning server 3 via the communication interface 44. In the case where completion notification has not been received (NO in ACT411), the processing of the processor 41 proceeds to ACT413. In the case where completion notification has been received (YES in ACT411), the processing of the processor 41 proceeds to ACT412. This processing of determining that completion notification has been received (YES in ACT411) corresponds to the processing procedure of ACT19 in FIG. 5. After that, the processing of the processor 41 proceeds to ACT412.

In ACT412, the processor 41 stores a completion flag in the record of the corresponding user ID in the achievement status management database 433 (FIG. 4) of the auxiliary storage device 43. That is, the processor 41 sets a value indicating that a response has been completed in the “completion flag” item of the record. This processing of ACT412 corresponds to the processing procedure of ACT20 in FIG. 5. After that, the processing of the processor 41 proceeds to ACT401.

In ACT413, the processor 41 determines whether or not the application notification associated with the planning ID and the user ID has been received from the POS terminal 1 via the communication interface 44. In the case where the application notification has not been received (NO in ACT413), the processing of the processor 41 proceeds to ACT401. In the case where the application notification has been received (YES in ACT413), the processing of the processor 41 proceeds to ACT414. This processing of determining that the application notification has been received (YES in ACT413) corresponds to the processing procedure of ACT32 in FIG. 6. After that, the processing of the processor 41 proceeds to ACT414.

In ACT414, the processor 41 deletes the user ID, the planning ID, and the completion flag stored in the achievement status management database 433 of the auxiliary storage device 43 in association with the received planning ID and user ID. This processing of ACT414 corresponds to the processing procedure of ACT33 in FIG. 6. After that, the processing of the processor 41 proceeds to ACT401.

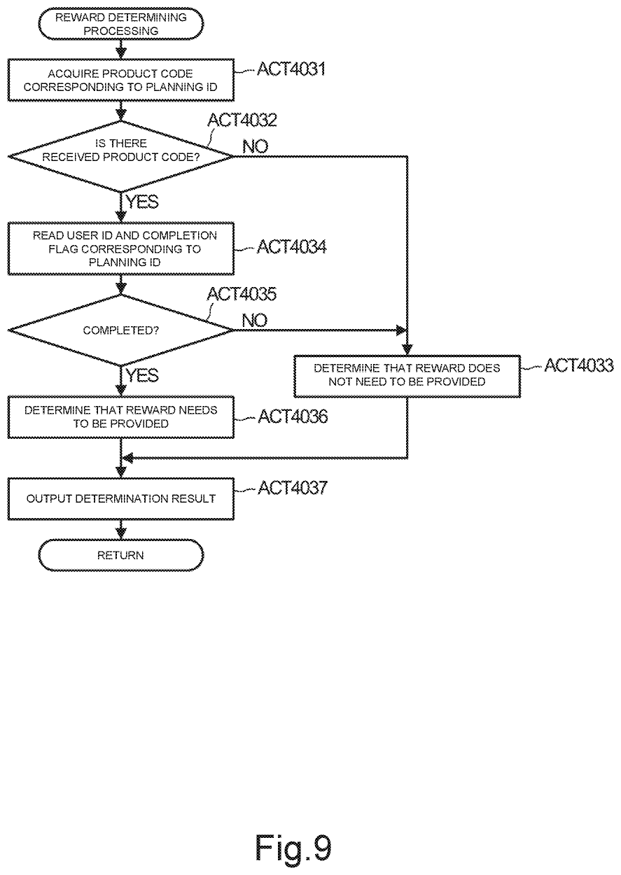

FIG. 9 is a flowchart illustrating details of the reward determining processing of ACT403 described above. In ACT4031, the processor 41 acquires, from the use condition management database 432 (FIG. 3) of the auxiliary storage device 43, the product code corresponding to the planning ID received from the POS terminal 1 in ACT402. This processing of ACT4031 corresponds to the processing procedure of ACT24 in FIG. 6. After that, the processing of the processor 41 proceeds to ACT4032.

In ACT4032, the processor 41 determines whether or not the product code included in the transaction data received from the POS terminal 1 in ACT401 is in the product code corresponding to the planning ID acquired in ACT4031. In the case where the product code included in the received transaction data is in the product code corresponding to the acquired planning ID (YES in ACT4032), the processing of the processor 41 proceeds to ACT4034. In the case where the product code included in the received transaction data is not in the product code corresponding to the acquired planning ID (NO in ACT4032), the processing of the processor 41 proceeds to ACT4033.

In ACT4033, the processor 41 determines that a reward does not need to be provided. After that, the processing of the processor 41 proceeds to the processing of ACT4037.

The processing of NO in ACT4032 and ACT4033 described above corresponds to the processing procedure of ACT25 in FIG. 6.

In ACT4034, the processor 41 reads, from the achievement status management database 433 (FIG. 4) of the auxiliary storage device 43, the value of the completion flag of the record corresponding to the user ID and the planning ID received from the POS terminal 1 in ACT402. This processing of ACT4034 corresponds to the processing procedure of ACT26 in FIG. 6. After that, the processing of the processor 41 proceeds to ACT4035.

In ACT4035, the processor 41 determines whether or not the read value of the completion flag is a value 1 indicating that a response has been completed. In the case where the completion flag is not a value indicating that a response has been completed (NO in ACT4035), the processing of the processor 41 proceeds to ACT4033. In the case where the completion flag is a value indicating that a response has been completed (YES in ACT4035), the processing of the processor 41 proceeds to ACT4036.

In ACT4036, the processor 41 determines that a reward needs to be provided. After that, the processing of the processor 41 proceeds to ACT4037.

The processing of ACT4035 and ACT4033 or ACT4036 corresponds to the processing procedure of ACT27 in FIG. 6.

In ACT4037, the processor 41 outputs, via the communication interface 44, the determination result of ACT4033 or ACT4036 to the POS terminal 1. This processing of ACT4037 corresponds to the processing procedure of ACT28 in FIG. 6. After that, the processing of the processor 41 proceeds to ACT404.

In accordance with the embodiment described above, the receipt server 4 refers to the relationship between a product code of a product to be purchased and a product code associated with a planning ID read from a two-dimensional code symbol of a planning receipt, and an achievement status of a reward providing condition associated with a user ID read from the two-dimensional code symbol to determine the necessity of provision of a reward to a subject corresponding to the user ID. Therefore, the receipt server 4 is capable of determining the necessity of provision of a reward without requiring a complicated configuration such as managing personal information of each person. Since the receipt server 4 issues a user ID without requiring personal information of each person, it is possible to provide a reward also to a non-member consumer. As described above, the receipt server 4 makes it possible to efficiently provide a reward in reward planning such as a questionnaire.

Note that although the planning server 3 and the receipt server 4 are different apparatus in the above-mentioned embodiment, the planning server 3 and the receipt server 4 may include one server.

Further, the order of the processing procedure shown in the flowchart in FIG. 7 to FIG. 9 is an example, and the present disclosure is not limited to the order. For example, the order of the processing procedure of ACT4031 and ACT4032 in FIG. 9 and the processing procedure of ACT4034 and ACT4035 may be reversed or the processing procedures may be performed in parallel with each other. As described above, the order of the processing procedures may be changed as long as there is no discrepancy between the corresponding processing procedure and the preceding or following processing procedure.

Further, although the POS terminal 1 issues two types of receipt of a planning receipt and a normal receipt in the above-mentioned embodiment, a planning receipt and a normal receipt may be integrated into one receipt by printing a ticket surface image of the planning receipt on the back surface of the normal receipt.

Note that an information processing apparatus is generally transferred while a program is stored in a main memory or an auxiliary storage device. However, the present disclosure is not limited thereto, and the information processing apparatus may be transferred while a program is not stored in a main memory or an auxiliary storage device. In this case, a program transferred separately from the information processing apparatus is written to a writable storage device included in the information processing apparatus in accordance with a user operation or the like. The program may be transferred by being recorded in a removable recording medium or through communication via a network. The recording medium may be of any form as long as the program can be stored, like a CD-ROM and a memory card, and the recording medium can be read by the apparatus. Further, the function obtained by installing or downloading a program may be implemented in cooperation with an OS or the like inside the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electronic receipt server in a point of sales (POS) system, comprising:
a communication interface configured to communicate with a POS terminal configured to perform payment processing on a purchased product and generate transaction data thereof;
a first management database that stores, in association with one of a product code for identifying a product and a payment amount, reward identification data for identifying a reward;
a second management database that stores, in association with user identification data for identifying a user, the reward identification data and an achievement status of a condition for the user to receive the reward; and
a processor configured to
acquire first transaction data from the POS terminal via the communication interface, the first transaction data including at least one of a first product code of a purchased product and a first payment amount of one or more purchased products,
search the first management database for first reward identification data associated with the first product code or a payment amount smaller than the first payment amount,
issue first user identification data and store in the second management database the first user identification data in association with the first reward identification data and
generate a code representing the first user identification data and the first reward identification data and instruct the POS terminal to print the generated code on a receipt corresponding to the first transaction data, wherein
the processor is further configured to, after the generated code is printed, when second transaction data is acquired from the POS terminal together with the first user identification data and the first reward identification data,
determine, based on an achievement status associated with the first user identification data and the first reward identification data in the second management database whether to provide the corresponding reward, and
upon determining to provide the corresponding reward, instruct the POS terminal to apply the reward to a transaction corresponding to the second transaction data.

2. The electronic receipt server according to claim 1, further comprising
a third management database that stores reward identification data in association with a product code, wherein
the processor determines whether to provide the corresponding reward further based on whether the second transaction data includes a product code associated with the first reward identification data in the third management database.

3. The electronic receipt server according to claim 2, wherein
the processor is further configured to acquire, before issuing the first user identification data, an internet address to be accessed to provide the reward, the internet address being associated with the first product code or the payment amount smaller than the first payment amount acquires, and generate the code further representing the acquired internet address.

4. The electronic receipt server according to claim 1, wherein
the processor is further configured to control the communication interface to transmit the generated code to the POS terminal as image data.

5. The electronic receipt server according to claim 3, wherein
the communication interface is further configured to communicate with an external planning server that manages the achievement status in association with the user identification data, and
the processor is further configured to, when the second transaction data is acquired from the POS terminal together with the first user identification data and the first reward identification data:
acquire, via the communication interface, the achievement status in association with the first user identification data from the external planning server,
store, in the second management database, the acquired achievement status in association with the first user identification data, and
acquire, from the POS terminal via the communication interface, application notification indicating that the reward has been applied to the transaction corresponding to the second transaction data.

6. The electronic receipt server according to claim 5, wherein
the processor deletes, in response to the acquisition of the application notification, the achievement status stored in the second management database in association with the acquired first user identification data.

7. A point of sales (POS) system, comprising:
a POS terminal configured to perform payment processing on a purchased product and generate transaction data thereof; and
an electronic receipt server including
a first communication interface configured to communicate with the POS terminal,
a first management database that stores, in association with one of a product code for identifying a product and a payment amount, reward identification data for identifying a reward,
a second management database that stores, in association with user identification data for identifying a user, the reward identification data and an achievement status of a condition for the user to receive the reward, and
a first processor configured to
acquire first transaction data from the POS terminal via the first communication interface, the first transaction data including at least one of a first product code of a purchased product and a first payment amount of one or more purchased products,
search the first management database for first reward identification data associated with the first product code or a payment amount smaller than the first payment amount,
issue first user identification data and store in the second management database the first user identification data in association with the first reward identification data, and
generate a code representing the first user identification data and the first reward identification data and control the first communication interface to transmit the generated code to the POS terminal, wherein
the first processor is further configured to, after the generated code is transmitted, when second transaction data is acquired from the POS terminal together with the first user identification data and the first reward identification data,
determine, based on an achievement status associated with the first user identification data and the first reward identification data in the second management database whether to provide the corresponding reward, and
upon determining to provide the corresponding reward, control the first communication transmit to the POS terminal an instruction to apply the reward to a transaction corresponding to the second transaction data, and
the POS terminal including
a second communication interface configured to communicate with the electronic receipt server,
a reading device configured to read a code symbol, and
a second processor configured to
register a product code of a purchased product and generate transaction data thereof in a transaction,
when a code symbol is not read by the reading device, control the second communication interface to transmit the generated transaction data to the electronic receipt server, and upon receipt of a code from the electronic receipt server, print the code on the receipt, and
when a code symbol is read by the reading device,
acquire user identification data and the planning reward identification data from the code symbol read by the reading device,
control the second communication interface to transmit the generated transaction data together with the acquired user identification data and the reward identification data, and
upon receipt of an instruction to apply a reward from the electronic receipt server, apply the reward to the transaction.

8. The POS system according to claim 7, wherein
the electronic receipt server further includes a third management database that stores reward identification data in association with a product code, and
the first processor determines whether to provide the corresponding reward further based on whether the second transaction data includes a product code associated with the first reward identification data in the third management database.

9. The POS system according to claim 7, wherein
the first communication interface is further configured to communicate with an external planning server that manages the achievement status in association with the user identification data, and
the first processor is further configured to, when the second transaction data is acquired from the POS terminal together with the first user identification data and the first reward identification data:
acquire, via the first communication interface, the achievement status in association with the first user identification data from the external planning server,
store, in the second management database, the acquired achievement status in association with the first user identification data,
acquire, from the POS terminal via the communication interface, application notification indicating that the reward has been applied to the transaction corresponding to the second transaction data, and
delete, in response to the acquisition of the application notification, the achievement status stored in the second management database in association with the acquired first user identification data.

10. A method carried out by an electronic receipt server in a point of sales (POS) system, the method comprising:
communicating, via a communication interface, with a POS terminal that performs payment processing on a purchased product and generates transaction data thereof;
storing, in a first management database, in association with one of a product code for identifying a product and a payment amount, reward identification data for identifying a reward;
storing, in a second management database, in association with user identification data for identifying a user, the reward identification data and an achievement status of a condition for the user to receive the reward;
acquiring first transaction data from the POS terminal, the first transaction data including at least one of a first product code of a purchased product and a first payment amount of one or more purchased products;
searching the first management database for first reward identification data associated with the first product code or a payment amount smaller than the first payment amount,
issuing first user identification data and storing in the second management database the first user identification data in association with the first reward identification data,
generating a code representing the first user identification data and the first reward identification data and causing the POS terminal to print the generated code on a receipt corresponding to the first transaction data, and
after the generated code is printed, when second transaction data is acquired from the POS terminal together with the first user identification data and the first reward identification data,
determining, based on an achievement status associated with the first user identification data and the first reward identification data in the second management database whether to provide the corresponding reward, and
upon determining to provide the corresponding reward, causing the POS terminal to apply the reward to a transaction corresponding to the second transaction data.

11. The electronic receipt server according to claim 5, wherein the processor is further configured to:
add a new record to the second management database to store the first user identification data in association with the first reward identification data, and
delete the added record in response to the acquisition of the application notification.

12. The electronic receipt server according to claim 1, wherein
the achievement status is updated according to update information transmitted by a portable terminal that has read the generated code from the receipt.

13. The POS system according to claim 8, wherein
the first processor is further configured to:
acquire, before issuing the first user identification data, an internet address to be accessed to provide the reward, the internet address being associated with the first product code or the payment amount smaller than the first payment amount, and
generate the code further representing the acquired internet address, and
the POS terminal further includes a print device configured to print the receipt on which the code representing the first user identification data, the first reward identification data, and the internet address is printed.
